(19) United States
(12) Patent Application Publication
(10) Pub. No.: US 2008/0023971 A1
(43) Pub. Date: Jan. 31, 2008

(54) Door-Lock Child Protecting Device

(75) Inventors: Ryujiro Akizuki, Kariya-shi (JP); Satoshi Suzuki, Anjo-shi (JP); Eiji Torii, Nukata-gun (JP); Yasuhiko Sono, Hekinan-shi (JP); Atsushi Katsurayama, Anjo-shi (JP); Shigeru Hayakawa, Chiryu-shi (JP); Katsutoshi Fukunaga, Chiryu-shi (JP); Toshihiro Kitamura, Okazaki-shi (JP)

Correspondence Address: BUCHANAN, INGERSOLL & ROONEY PC, POST OFFICE BOX 1404, ALEXANDRIA, VA, 22313-1404, US

(73) Assignees: AISIN SEIKI KABUSHIKI KAISHA, Kariya-shi, Aichi-ken (JP); AISIN KIKO CO., LTD., Hazu-gun, Aichi-ken (JP)

(21) Appl. No.: 11/667,729

(22) PCT Filed: Nov. 16, 2005
(86) PCT No.: PCT/JP05/21398

§ 371 Date: May 15, 2007

(30) Foreign Application Priority Data
Nov. 17, 2004 (JP) 2004-332682
Oct. 18, 2005 (JP) 2005-303258

(51) Int. Cl. E05B 65/20

(52) U.S. Cl. 292/201

(57) ABSTRACT

A door-lock child protecting device capable of preventing a child in a vehicle from opening a door is reduced in size. This device includes an open member (1) being movable in a direction of releasing a door lock, an inside lever (2) for being actuated by an input from an inside handle, a movable operating member (3) for moving the open member (1) in the direction of releasing the door lock, a child protecting member (4) capable of being switched by an operation of an operating portion (41) between a set position to execute child protection and an unset position not to execute child protection, and a base (5). The child protecting member (4) is rectilinearly movable between the set position (S1) and the unset position (S2) and inhibited from being rotated with respect to the base (5).

### TECHNICAL FIELD

The present invention relates to a door-lock child protecting device which executes a child protecting function of preventing a door from being opened even if a child in a passengers' room in a vehicle tries to open the door.

### BACKGROUND ART

A door-lock child protecting device is disclosed in Japanese Unexamined Patent Publication No. 2003-3714. As shown in FIG. 15, this device includes a base 6X, an open lever 1X which is movable in a direction of releasing a door lock from a latched state, an inside lever 2X which is rotated in the direction of the arrow A1 (i.e., in the direction of releasing the door lock from the latched state) upon an input from an inside handle for opening the door, and a child protecting member 4X which can be switched between a set position for executing child protection and an unset position for not executing child protection. The inside lever 2X is rotatable on a shaft portion 22X with respect to the base 6X.

As shown in FIG. 15, in a normal use mode in which a child protecting function is not executed, a projection 45X of the child protecting member 4X is fitted in a first hole 61X of the base 6X. A fore end 20X of the inside lever 2X and a projection 40X of the child protecting member 4X are allowed to face each other. Therefore, when a user operates the inside handle for opening the door and rotates the inside lever 2X in the direction of the arrow A1 (i.e., in the direction of releasing the door lock from the latched state), the fore end 20X of the inside lever 2X pushes the projection 40X of the child protecting member 4X and the child protecting member 4X is rotated in the direction of the arrow A1 around the projection 45X which is formed on a longitudinally intermediate part of the child protecting member 4X. Consequently, the open lever 1X is moved in the direction of releasing the door lock from the latched state and allows the door to be opened.

On the other hand, when the child protecting function is executed, an operating portion 41X of the child protecting member 4X is operated by a user, so the child protecting member 4x is moved in the direction of the arrow Y1 and the projection 45X of the child protecting member 4X is fitted in a second hole 62X of the base 6X. As a result, the fore end 20X of the inside lever 2X and the projection 40X of the child protecting member 4X are inhibited from facing each other. Therefore, even if a child or another person operates the inside handle in a passenger's room in a vehicle in the direction of opening the door and rotate the inside lever 2X in the direction of the arrow A1, the fore end 20X of the inside lever 2X does not push the projection 40X of the child protecting member 4X. Accordingly, the child protecting member 4X is not rotated and does not move the open lever 1X in the direction of releasing the door lock from the latched state. Consequently, the open lever 1X is inhibited from moving in the direction of releasing the door lock and the latched state of the door (i.e., the closed state of the door) is maintained. [Patent Document No. 1 Japanese Unexamined Patent Publication No. 2003-3714

### DISCLOSURE OF THE INVENTION

### Problems to be Solved by the Invention

According to the above related art, when the fore end 20X of the inside lever 2X and the projection 40X of the child protecting member 4X are inhibited from facing each other, the child protecting function is executed and a child or another person is prevented from opening the door with mischief. In recent years, there has been demand for further downsizing automobile component parts. The above related art, however, employs a structure in which the whole of the child protecting member 4X is rotated around the projection 45X formed on a longitudinally intermediate part of the child protecting member 4X. Therefore, there is a limit in downsizing this door-lock child protecting device because of a space necessary for this rotation.

For example, a space is necessary for rotation of one end portion 4Xa extending from the projection 45X to one end of the child protecting member 4X in the longitudinal direction. Further another space is necessary for rotation of the other end portion 4Xb extending from the projection 45X to the other end of the child protecting member 4X in the longitudinal direction. When such a structure to rotate the child protecting member 4X around the projection 45X formed on the longitudinally intermediate part is employed, there is a limit in decreasing the necessary space and downsizing the door-lock child protecting device.

The present invention has been conceived in view of the aforementioned circumstances. It is an object of the present invention to provide a door-lock child protecting device which is advantageous in being reduced in size.

### Means for Dissolving the Problems

A door-lock child protecting device according to the present invention comprises an open member being movable in a direction of releasing a door lock from a latched state, an inside lever for being actuated by an input from an inside handle, a movable operating member for moving the open member in the direction of releasing the door lock from the latched state upon the actuation of the inside lever, a child protecting member capable of being switched by an operation of an operating portion between a set position to execute child protection and an unset position not to execute child protection, and a base having the open member, the inside lever, the movable operating member and the child protecting member thereon. The child protecting member is arranged to be rectilinearly movable between the set position and the unset position, and it is inhibited from being rotated with respect to the base.

### (Advantages of the Invention

In the door-lock child protecting device according to the present invention, the child protecting member is arranged to be rectilinearly movable between the set position and the unset position, and it is inhibited from being rotated with respect to the base. Therefore, a space for rotating the whole of the child protecting member is not necessary and the door-lock child protecting device can be advantageously reduced in size.

Also as mentioned above, the child protecting member is arranged to be rectilinearly movable between the set position and the unset position; however, it is inhibited from being rotated with respect to the base. Accordingly, an opening on a door panel has only to be formed in a direction of moving the operating portion (in the rectilinear direction) and does not have to be formed in a rotational direction. Accordingly, the opening formed on the door panel can be as small as possible and this is advantageous in preventing intrusion of rainwater, etc. from the inside of the door panel to the inside of a passengers' room in a vehicle.

### BRIEF DESCRIPTION OF THE DRAWINGS

FIG. 1 is a perspective view of a door-lock child protecting device according to a first preferred embodiment of the present invention.

FIG. 2 is a plan view of a child protecting member according to the first preferred embodiment.

FIG. 3 is a cross-sectional view illustrating the structure of assembling the child protecting member and a base according to the first preferred embodiment.

FIG. 4 is a view illustrating a state before an inside lever is rotated in a direction of opening a door in the first preferred embodiment, when the child protecting member is disposed in an unset position.

FIG. 5 is a view illustrating a state after the inside lever is rotated in the direction of opening the door in the first preferred embodiment, when the child protecting member is disposed in the unset position.

FIG. 6 is a view illustrating a state before the inside lever is rotated in the direction of opening the door in the first preferred embodiment, when the child protecting member is disposed in a set position.

FIG. 7 is a view illustrating a state after the inside lever is rotated in the direction of opening the door in the first preferred embodiment, when the child protecting member is disposed in the set position.

FIG. 8 is a cross-sectional view showing that an operating portion of the child protecting member penetrates an opening of a wall body of a door panel in the first preferred embodiment.

FIG. 9 is a perspective view of a door-lock child protecting member and a bush according to a second preferred embodiment of the present invention.

FIG. 10 is a front view of a door lock device on which a door-lock child protecting device according to the second preferred embodiment is mounted.

FIG. 11 is a perspective view of a bush to be attached on a guide portion of the child protecting member, according to the second preferred embodiment.

FIG. 12(a) is a constructional view showing that the guide portion of the child protecting member is deformed by deflection when a deformation suppressing portion is not formed, and FIG. 12(b) is a constructional view showing that, according to the second preferred embodiment, a deformation suppressing portion suppresses deformation by deflection of the guide portion of the child protecting member.

FIG. 13 is a plan view of a child protecting member according to a third preferred embodiment of the present invention.

FIG. 14 is a plan view of a child protecting member according to a fourth preferred embodiment of the present invention.

FIG. 15 is an explanatory view of a door-lock child protecting device according to the related art.

### BEST MODES FOR CARRYING OUT THE INVENTION

The present invention can be exemplified in the following modes. In one example mode, the child protecting member has a first engaging portion, the base has a second engaging portion engaged with the first engaging portion of the child protecting member, one of the first engaging portion and the second engaging portion is a concave portion and the other of the first engaging portion and the second engaging portion is a convex portion engaged movably with the concave portion. In this case, the child protecting member is arranged to be rectilinearly movable between the set position and the unset portion, and it is inhibited from being rotated with respect to the base by the first engaging portion and the second engaging portion.

In another example mode, the child protecting member has a guide portion for guiding the movable operating member. In this case, the movable operating member can be moved with respect to the base along the guide portion of the child protecting member. The movable operating member can be a bush.

In still another example mode, the guide portion of the child protecting member has a circular arc guide surface. In this case, the movable operating member is rotated with respect to the base along the guide surface of the guide portion of the child protecting member. In association with the above rotation, the movable operating member moves the open member in the direction of releasing the door lock from the latched state. As mentioned above, the construction is employed in which the child protecting member is allowed to be rectilinearly moved between the set position and the unset position, but the child protecting member is inhibited from being rotated. Accordingly, the construction is employed in which the movable operating member assembled on the guide portion of the child protecting member is rotated. Since the movable operating member, which is thus assembled on the guide portion of the child protecting member, is smaller in size than the child protecting member, there is little or no increase in the necessary space when the movable operating member is rotated.

In still another example mode, when the child protecting member is disposed in the unset position, namely, the position for not executing the child protecting function, the amount of engagement between the first engaging portion of the child protecting member and the second engaging portion of the base is larger than when the child protecting member is disposed in the set position. In the unset position, the movable operating member is rotated to move the open member upon the actuation of the inside lever. Therefore, it is preferable to increase the amount of engagement between the child protecting member and the base. In this case, the posture of the child protecting member can be stabilized and accordingly the movable operating member can be moved smoothly; thus, operations for opening the door can be carried out smoothly.

In still another example mode, a deformation suppressing portion for suppressing deformation of the guide portion of the child protecting member is provided on at least one of the child protecting member, the movable operating member and the base. Consequently, a loss is reduced or avoided in transmitting application force. Operational feelings are also suppressed from being degraded. In one example mode, the deformation suppressing portion is constituted by a first extending portion and a second extending portion extended from the movable operating member. In this case, the first extending portion and the second extending portion are formed at such positions as to sandwich a sandwiched portion of the child protecting member in its thickness direction. Thus, deformation by deflection of the guide portion can be effectively suppressed. In one example mode, the first extending portion and the second extending portion form a U-shape or a channel-shape in a cross section perpendicular to moving directions of the movable operating member. In this case, deformation by deflection of the guide portion can be suppressed effectively. The term “sandwich” is used herein to include both sandwiching something with a gap therebetween and sandwiching something without any gap therebetween.

Instill another example mode, in the child protecting member, the sandwiched portion sandwiched by the first extending portion and the second extending portion has a thickness which is increased from that of a neighboring portion of the sandwiched portion. In this case, the posture of the movable operating member is stabilized, and deformation by deflection of the guide portion of the child protecting member is suppressed. The first extending portion and the second extending portion of the movable operating member are provided at the side of an inner circumference of rotation tracks of the movable operating member. In this case, the first extending portion and the second extending portion can be suppressed from protruding excessively at the side of an outer circumference of these rotation tracks, so this construction is advantageous in downsizing the door-lock child protecting device.

It is preferable that at least one of the base and the child protecting member has a rotation restraining portion for suppressing rotation of the child protecting member.

In still another example mode, the movable operating member has a portion which is to be pushed by the inside lever and a portion which is to push the open lever.

### First Preferred Embodiment

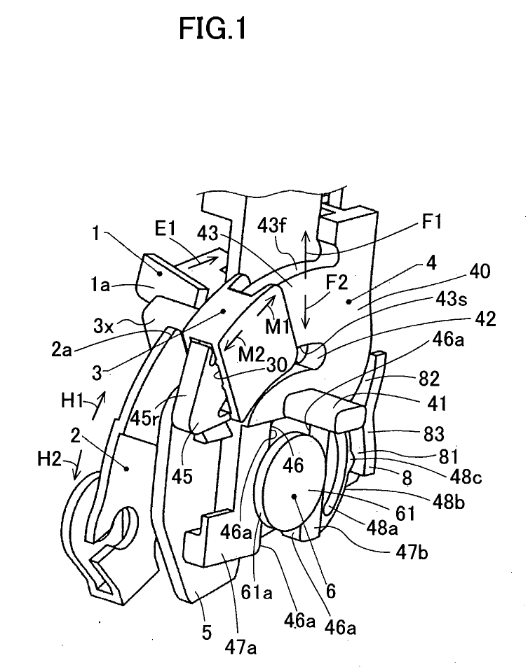

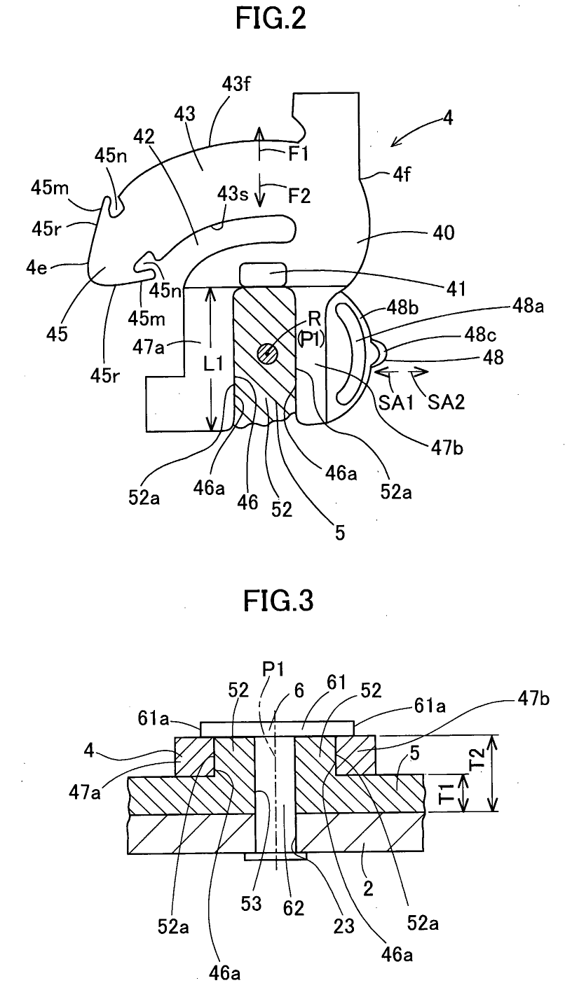

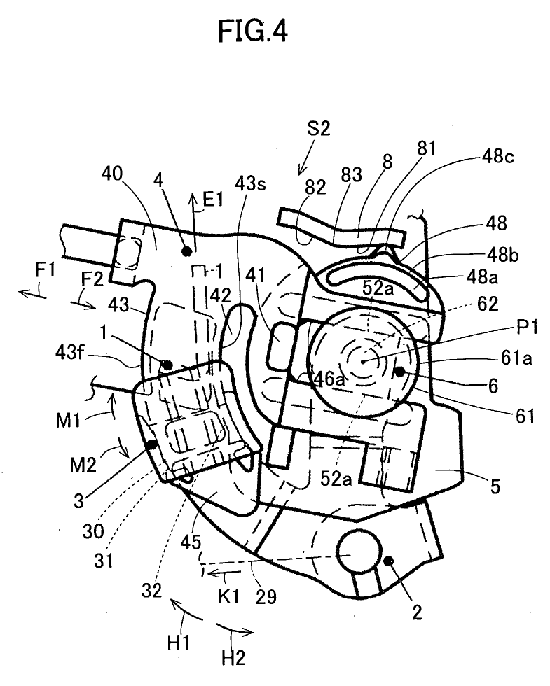

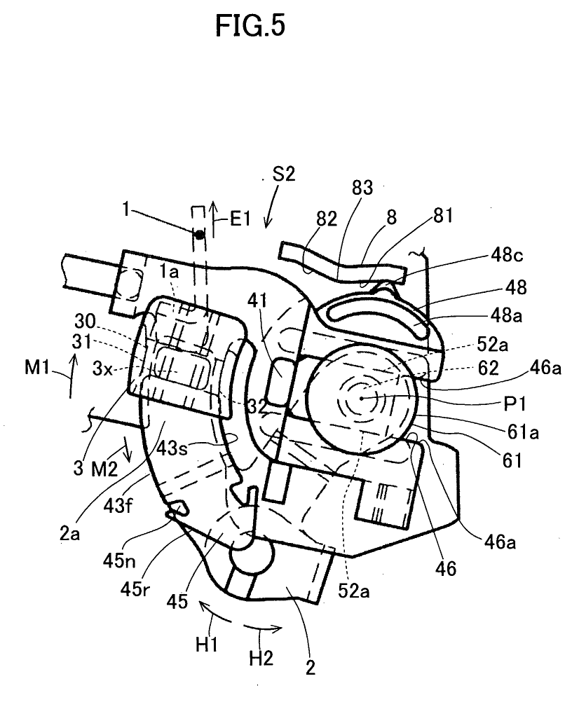

Hereinafter, a first preferred embodiment of the present invention will be described with reference to the drawings. This preferred embodiment of the present invention is applied to a door-lock child protecting device mounted inside a door of a vehicle rear seat. FIG. 1 is a perspective view of a door-lock child protecting device. FIG. 2 illustrates a child protecting member 4 as a main component. FIG. 3 illustrates the structure of assembling the child protecting member 4 and a base 5. FIGS. 4 and 5 show that the child protecting member 4 is disposed in an unset position S2, namely, in a normal use mode so as not to execute a child protecting function. Of these drawings, FIG. 4 illustrates a state before an inside lever 2 is rotated in a direction of opening the door and FIG. 5 illustrates a state after the inside lever 2 is rotated in the direction of opening the door.

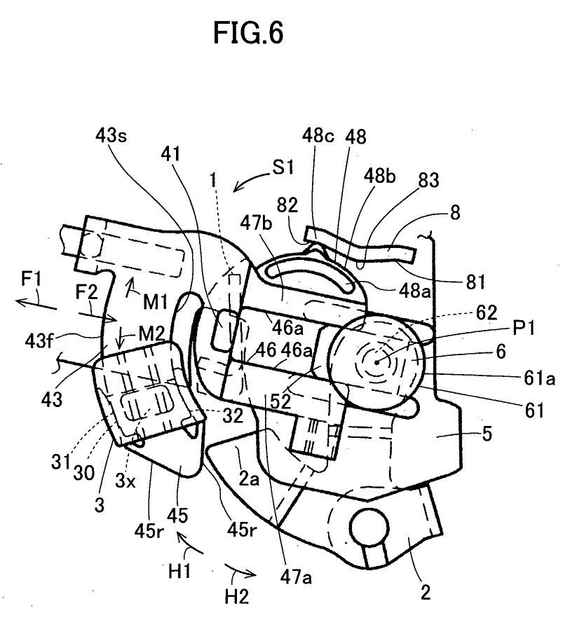

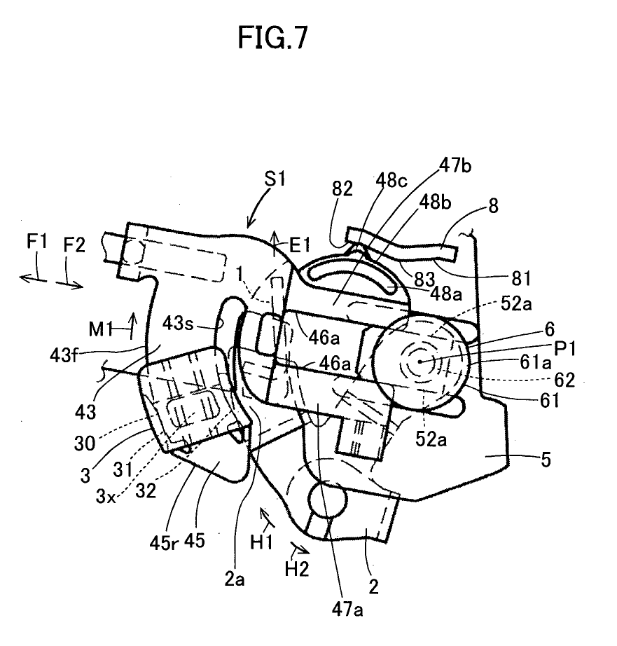

On the other hand, FIGS. 6 and 7 show that the child protecting member 4 is disposed in a set position S1 so as to execute the child protecting function. Of these drawings, FIG. 6 illustrates a state before the inside lever 2 is rotated in the direction of opening the door and FIG. 7 illustrates a state after the inside lever 2 is rotated in the direction of opening the door.

As shown in FIG. 1, the door-lock child protecting device according to the present embodiment comprises an open lever 1 which serves as an open member to open a door, an inside lever 2 which is to be rotated by an operation of an inside handle by a passenger in a passengers' room in a vehicle for opening the door, a bush 3 serving as a movable operating member, a child protecting member 4 which can execute a child protecting function, a base 5 serving as a susstrate, and a holder 6 which prevents displacement of the child protecting member 4.

As shown in FIG. 2, the child protecting member 4 has a plate shape and comprises a main body 40, an operating portion 41 formed on the main body 40 so as to protrude in the thickness direction of the main body 40 and having the shape of a projection to be moved by a user, a guide portion 43 which extends in an arm shape from the main body 40 in a circular arc shape having a predetermined center of curvature R (corresponding to a shaft center P1 of the holder 6, which will be mentioned later), a snap portion 45 formed at a fore end of the guide portion 43 and serving as a bush stopper, a pair of leg portions 47a, 47b forming a first engaging portion 46 as a concave portion, and a temporary position holding portion 48 which holds the posture of the child protecting member 4. A groove portion 42 is formed on the inner circumferential side of the guide portion 43. The groove portion 42 forms a space for moving the bush 3.

As shown in FIG. 2, the first engaging portion 46 has a length L1. The operating portion 41 can be moved by a user in the directions of the arrows F1, F2. When the operating portion 41 is thus moved, the child protecting member 4 is moved in the directions of the arrows F1, F2. The direction of the arrow F1 is a direction of executing the child protecting function and corresponds to an outward direction of rotation tracks of the bush 3. The direction of the arrow F2 is a direction of not executing the child protecting function and corresponds to an inward direction of the rotation tracks of the bush 3.

The guide portion 43 of the child protecting member 4 has a first guide surface 43f and a second guide surface 43s which extend in a circular arc arm shape with a center of curvature R. The temporary position holding portion 48 is used for keeping the posture of the child protecting member 4 in the set position S1 or the posture of the child protecting member 4 in the unset position S2 temporarily, and includes a concave portion 48a which is an elongate groove in a circular arc shape, an elastic arm portion 48b which can be elastically deformed by the concave portion 48a in the directions of the arrows SA1, SA2, and a holding pawl portion 48c formed on the elastic arm portion 48b so as to protrude outwardly.

As shown in FIG. 2, the first engaging portion 46, which is a concave portion of the child protecting member 4, has a pair of first engaging surfaces 46a which extend rectilinearly in the directions of the arrows F1, F2 and are substantially in parallel with each other. The pair of first engaging surfaces 46a, 46a face each other and can serve as rotation-restraining portions to restrain rotation of the child protecting member 4.

As shown in FIGS. 2 and 3, the base 5 has a second engaging portion 52 which is a convex portion engaged with the concave first engaging portion 46 of the child protecting member 4. The second engaging portion 52 of the base 5 has a pair of second engaging surfaces 52a, 52a which extend rectilinearly in the directions of the arrows F1, F2 and are substantially in parallel with each other. The second engaging surfaces 52a oppose to the first engaging surfaces 46a and can serve as rotation-restraining portions to restrain rotation of the child protecting member 4 together with the first engaging surfaces 46a.

As shown in FIG. 2, the snap portion 45 (a portion for preventing removal of the movable operating member 3) of the child protecting member 4 includes stopping pawl portions 45m (engaging portions) having slant surfaces 45r, and grooves 45n which elastically deform ends of the stopping pawl portions 45m (concave portions which elastically deforms the guide portion 43). The bush 3 serving as a movable operating member is assembled on the child protecting member 4. The bush 3 is disposed on the guide portion 43 through the snap portion 45 of the child protecting member 4, while the bush 3 is brought in contact with the slant surfaces 45r of the stopping pawl portions 45m and elastically deforms the stopping pawl portions 45m inwardly. Consequently, the bush 3 is slidably attached on the guide portion 43 of the child protecting member 4. Removal of the bush 3 is prevented by the stopping pawn portions 45m. The bush 3 has a push portion 3x which is to be pushed by the inside lever 2 and is to push the open lever 1 in the direction of releasing the door lock from the latched state, as shown in FIG. 1.

FIG. 3 shows a cross-sectional structure of the child protecting member 4 and the inside lever 2 assembled on the base 5. The holder 6 includes a disk-shaped flange portion 61 serving as a stopper and a shaft portion 62 which is integrally formed with the flange portion 61 and fitted in a mounting hole 53 of the base 5 whose outer diameter is smaller than that of the flange portion 61. The flange portion 61 has an outer circumferential surface 61a. As shown in FIG. 3, the shaft portion 62 of the holder 6 is fitted in the mounting hole 53 of the second engaging portion 52 of the base 5 and a mounting hole 23 of the inside lever 2. Accordingly, the inside lever 2 can be rotated around the shaft portion 62 of the holder 6. The flange portion 61 of the holder 6 enables the child protecting member 4 to be assembled on the second engaging portion 52 of the base 5 and prevents displacement of the child protecting member 4 in a direction of departing from the base 5.

When the child protecting member 4 is thus assembled on the base 5, the leg portions 47a, 47b of the child protecting member 4 are fitted with the second engaging portion 52 of the base 5. In other words, the first engaging surfaces 46a of the first engaging portion 46 of the child protecting member 4 are slidably engaged with the second engaging surfaces 52a of the second engaging portion 52 of the base 5 in the directions of the arrows F1, F2. Accordingly, the child protecting member 4 is arranged to be rectilinearly movable by sliding with respect to the base 5 in the directions of the arrows F1, F2 (in perpendicular directions to the plane of paper in FIG. 3).

As shown in FIG. 3, the base 5 having a thickness T1 is reinforced by the second engaging portion 52 having a convex shape in a cross section and a thickness T2 (T2>T1). Since the child protecting member 4 is assembled on the thus-reinforced second engaging portion 52 of the base 5, this structure is advantageous in reinforcing the part on which the child protecting member 4 is assembled.

As shown in FIG. 4, the bush 3 has a sliding recess 30 which is fitted with the guide portion 43 of the child protecting member 4. The sliding recess 30 has a first circular arc surface 31 on an outer circumferential side and a second circular arc surface 32 on an inner circumferential side. The curvature centers R of the first circular arc surface 31 and the second circular arc surface 32 basically correspond to the shaft center P1 of the holder 6. The first circular arc surface 31 of the bush 3 has approximately the same curvature as that of the first guide surface 43f of the child protecting member 4. The first circular arc surface 31 of the bush 3 slides along the first guide surface 43f of the guide portion 43 of the child protecting member 4 which extends in a circular arc shape. Besides, the second circular arc surface 32 of the bush 3 has approximately the same curvature as that of the second guide surface 43s of the child protecting member 4. The second circular arc surface 32 of the bush 3 slides along the second guide surface 43s of the guide portion 43 of the child protecting member 4. Therefore, the bush 3 can make circular arc movements along the guide portion 43 of the child protecting member 4 in the directions of the arrows M1, M2. In other words, the child protecting member 4 is not rotated with respect to the base 5. However, the bush 3, which is smaller in size than the child protecting member 4, can be rotated along the guide portion 43 of the child protecting member 4. The direction of the arrow M1 is a direction of releasing the door lock from the latched state.

As shown in FIG. 1, the open lever 1 can be moved in the direction of releasing the door lock from the latched state, i.e., the direction of the arrow E1. When the open lever 1 is moved in the direction of the arrow E1, the door is allowed to be opened.

The inside lever 2 is held by the base 5 so as to be rotatable in the directions of the arrows H1, H2 around the shaft center P1 of the holder 6. The direction of the arrow H1 is a direction of releasing the door lock from the latched state. The inside lever 2 is pulled by a cable 29 in the direction of the arrow K1 (as shown in FIG. 4) upon an input from the inside handle which is provided in a passengers' room in a vehicle for opening the door, and the inside lever 2 is rotated in the direction of the arrow H1 around the shaft center P1 of the holder 6.

The door-lock child protecting device according to the first preferred embodiment is operated as follows. First, in a normal use mode, in which the child protecting function is not executed, as shown in FIGS. 4 and 5, the operating portion 41 of the child protecting member 4 is operated by a user so as to move the child protecting member 4 rectilinearly with respect to the base 5 in the direction of the arrow F2 (i.e., in the direction of carrying out the normal use mode). Consequently, the child protecting member 4 is disposed in the unset position S2, namely, the position for not executing the child protecting function. In this case, owing to elastic deformation of the elastic arm portion 48b of the temporary position holding portion 48, the holding pawl portion 48c goes beyond a node 83 of a click member 8 and presses a first slant surface 81. So, the child protecting member 4 is held in the unset position S2 and suppressed from being displaced to the set position S1. The click member 8 is provided on the base 5 and has the node 83 between the first slant surface 81 and a second slant surface 82. The node 83 and the first slant surface 81 of the click member 8 serve as a first holding element for holding the child protecting member 4 in the unset position S2.

When the inside handle is operated by a vehicle user in the direction of opening the door under the condition that the child protecting member 4 is disposed in the unset position S2, as mentioned above, the inside lever 2 is rotated in the direction of the arrow H1 (in the direction of releasing the door lock from the latched state, namely, in the direction of opening the door) around the shaft center P1 of the holder 6. As a result, as shown in FIG. 5, a fore end 2a of the inside lever 2 pushes the push portion 3x of the bush 3 in the direction of the arrow M1 (in the direction of releasing the door lock from the latched state, i.e., in the direction of opening the door). Then, although the child protecting member 4 is not rotatable in this preferred embodiment, the bush 3, which is smaller in size than the child protecting member 4, is rotated along the guide portion 43 of the child protecting member 4 in the direction of the arrow M1 (in the direction of releasing the door lock from the latched state, i.e., in the direction of opening the door) around the shaft center P1 of the holder 6. Accordingly, the push portion 3x of the bush 3 (as shown in FIG. 1) pushes a depressable portion 1a of the open lever 1, and moves the open lever 1 in the direction of the arrow E1 (in the direction of releasing the door lock from the latched state, i.e., in the direction of opening the door). Consequently, the door of the vehicle is allowed to be opened or closed by an operation of the inside handle.

Second, when the child protecting function is executed, as shown in FIG. 6, the operating portion 41 of the child protecting member 4 is moved by a user in the direction of the arrow F1 so as to move the child protecting member 4 with respect to the base 5 in the direction of the arrow F1 (i.e., in the direction of executing the child protecting function). Consequently, the child protecting member 4 is disposed in the set position S1, namely, in the position for executing the child protecting function. In this case, owing to elastic deformation of the elastic arm portion 48b of the temporary position holding portion 48, the holding pawl portion 48c goes beyond the node 83 of the click member 8 and presses the second slant surface 82. So, the child protecting member 4 is held in the set position S1 and suppressed from being displaced to the unset position S2. The node 83 and the second slant surface 82 of the click member 8 serve as a second holding element for holding the child protecting member 4 in the set position S1.

When the inside handle in a passengers' room in a vehicle is operated for opening the door by a user (usually a child) in the passengers' room in the vehicle under the condition that the child protecting member 4 is thus disposed in the set position S1, as shown in FIG. 7, the inside lever 2 is rotated around the shaft center P1 of the shaft portion 62 of the holder 6 in the direction of the arrow H1. As shown in FIG. 7, however, since the bush 3 escapes in the direction of the arrow F1, the fore end 2a of the inside lever 2 is inhibited from coming in contact with the push portion 3x of the bush 3. In other words, although the construction in which the child protecting member 4 is not rotatable is employed, even when the inside lever 2 is rotated around the shaft center P1 of the shaft portion 62 of the holder 6 in the direction of the arrow H1, the fore end 2a of the inside lever 2 does not come in contact with the bush 3 and strikes at the air. Accordingly, the bush 3 is inhibited from moving along the guide portion 43 of the child protecting member 4 in the direction of the arrow M1 (i.e., in the direction of opening the door). Consequently, the open lever 1 is inhibited from moving in the direction of the arrow E1 (i.e., in the direction of opening the door). Thus, the vehicle door is prevented from opening and the child protecting function can be executed.

As mentioned above, according to the present preferred embodiment, the child protecting member 4 is arranged to be rectilinearly movable in the directions of the arrows F1, F2 between the set position S1 and the unset position S2 and inhibited from being rotated with respect to the base 5. Therefore, in contrast to the aforementioned related art, a space for rotating the child protecting member 4 is not necessary and this structure is advantageous in reducing the whole size of the door-lock child protecting device.

According to the present preferred embodiment, the first engaging portion 46 of the child protecting member 4 has a length L1 (as shown in FIG. 2). Therefore, the first engaging portion 46 of the child protecting member 4 can secure a distance of sliding against the second engaging portion 52 of the base 5. Therefore, when the child protecting member 4 is rectilinearly moved with respect to the base 5, the child protecting member 4 is restricted from rattling.

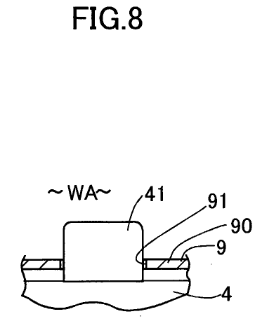

The abovementioned door-lock child protecting device is mounted inside the door panel 9 of the door. Accordingly, as shown in FIG. 8, the operating portion 41 for switching the child protecting member 4 between the set position S1 and the unset position S2 penetrates an opening 91 formed on a wall body 90 of the door panel 9 of the door and exposes to a space WA. It is preferable that the opening area of this opening 91 is as small as possible in order to prevent intrusion of rainwater, etc. from the inside of the door panel to the inside of a passengers' room in a vehicle. The space WA is a gap between mating surfaces of the door and the vehicle body. It is to be noted that when the door is closed, the operating portion 41 is not operated either from the inside of the vehicle or from the outside of the vehicle. While the door is open, the operating portion 41 is operated by a user.

According to the present preferred embodiment, the child protecting member 4 is arranged to be rectilinearly movable between the set position S1 and the unset position S2 but inhibited from being rotated with respect to the base 5, as mentioned above. Therefore, the aforementioned opening 91 of the door panel 9 has only to be formed in the direction of moving the operating portion 41, and the opening 91 does not have to be formed in the direction of rotating the bush 3. Accordingly, this structure is advantageous in decreasing the opening area of the opening 91 formed on the wall body 90 of the door panel 9 as much as possible.

In opening the door, an operational load is applied on the bush 3, which transmits application force of the inside lever 2 to the open lever 1. In this respect, since the bush 3 is a separate member from the child protecting member 4 in the present preferred embodiment, the bush 3 can be formed of a material having a higher rigidity (e.g., a resin such as a polyacetal resin and a polyacrylic resin, or a metal) and be prevented from being damaged by long-term use.

According to the present preferred embodiment, as understood from FIGS. 4 to 7, even when the bush 3 is rotated along the guide portion 43 of the child protecting member 4, rotation tracks of the bush 3 substantially fall within a projected area of the child protecting member 4. Namely, rotation tracks of the bush 3 exist in an area between one end 4e and the other end 4f of the child protecting member 4, as shown in FIG. 2, and exist substantially within the child protecting member 4. Therefore, there is no need to provide a space for rotating the bush 3 separately in addition to the projected area of the child protecting member 4. Also in this meaning, this structure is advantageous in downsizing the door-lock child protecting device.

Moreover, as understood from FIGS. 4 to 7, since the center of rotation of the inside lever 2 is designed to be identical with the center of rotation of the bush 3, an increase in a space for rotation can be prevented. Also in this meaning, this structure is advantageous in downsizing the door-lock child protecting device.

According to the present preferred embodiment, when the child protecting member 4 is disposed in the unset position S2, namely, the position for not executing the child protecting function, the amount of engagement between the first engaging portion 46 of the child protecting member 4 and the second engaging portion 52 of the base 5 is larger than when the child protecting member 4 is disposed in the set position S1, namely, the position for executing the child protecting function. In the unset position S2, the bush 3 is rotated to actuate the open lever 1 upon an operation of the inside lever 2, so the child protecting member 4 is requested to attain a high posture stability and it is preferable to increase the amount of engagement between the child protecting member 4 and the base 5.

In contrast, under the condition that the child protecting member 4 is disposed in the set position S1, in which the inside lever 2 is made to strike at the air, even when the inside lever 2 is rotated in the direction of the arrow H1, the inside lever 2 does not come in contact with the bush 3 and strikes at the air. Therefore, the amount of engagement between the first engaging portion 46 of the child protecting member 4 and the second engaging portion 52 of the base 5 is not requested to be as large as that of the unset position S2.

### Second Preferred Embodiment

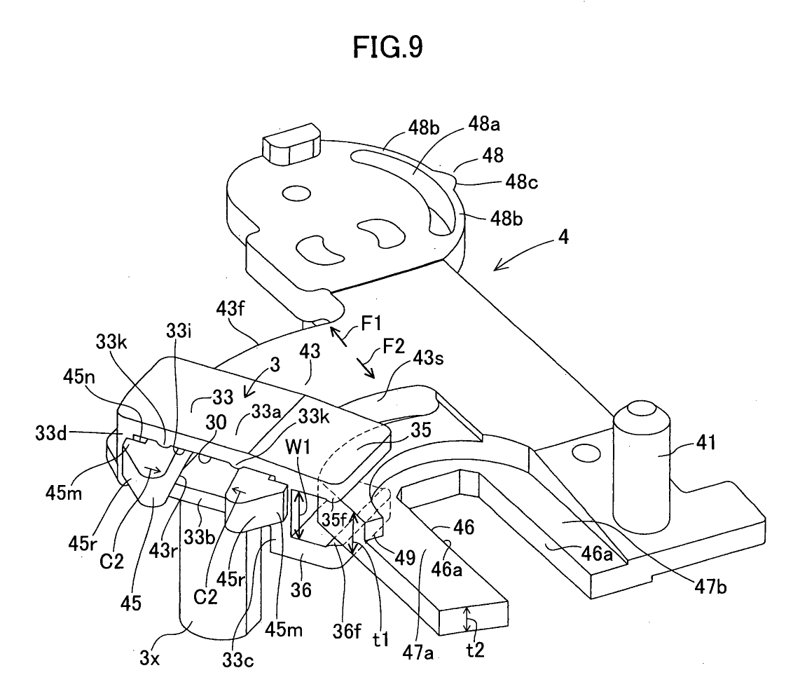

FIGS. 9 to 12 illustrate a second preferred embodiment of the present invention. This preferred embodiment has basically the same construction, effects and advantages as those of the first preferred embodiment. Hereinafter, description will be made mainly on parts different from those of the first preferred embodiment. Basically the same reference numerals designate commonly used parts. Also in this preferred embodiment, when the inside lever 2 for opening the door is operated, the bush 3 is moved along the guide portion 43 of the child protecting member 4. At this time, there is a fear that the guide portion 43 of the child protecting member 4 might be deformed by deflection, depending on conditions. In this case, there is a fear that a loss might be caused in transmitting application force or that operational feelings of the inside handle might be degraded.

In this preferred embodiment, a deformation suppressing portion for suppressing deformation by deflection of the guide portion 43 of the child protecting member 4 is provided on the bush 3. Therefore, when the inside lever 2 is operated in the direction of releasing the door lock from the latched state, the guide portion 43 of the child protecting member 4 is suppressed from being deformed by deflection. Consequently, defects such as a loss generation in transmitting application force and degradation of operational feelings are prevented.

The deformation suppressing portion will be described in more detail hereinafter. As shown in FIG. 9, the bush 3 is provided with a box-like portion 33 having the sliding recess 30, and a flange-shaped first extending portion 35 and a flange-shaped second extending portion 36 both formed on the box-like portion 33 and serving as a deformation suppressing portion. The first extending portion 35 and the second extending portion 36, which are formed on an end of the bush 3, and which is close to the first engaging portion 46 of the child protecting member 4.

As shown in FIG. 9, the first extending portion 35 and the second extending portion 36 sandwich a sandwiched portion 49 (a portion being close to the first engaging portion 46) of the child protecting member 4 in its thickness direction. Accordingly, the bush 3 places a greater degree of restraint. In association with this, the guide portion 43 of the child protecting member 4 also places a greater degree of restraint. As a result, deformation by deflection of the guide portion 43 is effectively suppressed. It is to be noted that the first extending portion 35 and the second extending portion 36 form a U-shape or a channel-shape in a cross section perpendicular to the moving directions of the bush 3. As a result, deformation by deflection of the guide portion 43 is more effectively suppressed.

It is also to be noted that the first extending portion 35 and the second extending portion 36 can sandwich the sandwiched portion 49 either with or without a gap between the first extending portion 35 or the second extending portion 36 and the sandwiched portion 49.

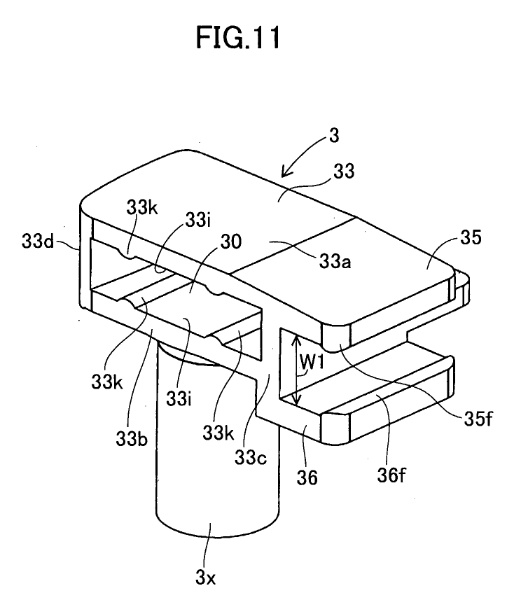

As shown in FIG. 11, the box-like portion 33 of the bush 3 has plate-like portions 33a, 33b which face each other and plate-like portions 33c, 33d which face each other. The plate-like portion 33c is disposed on the inner circumferential side of rotation tracks of the bush 3. The plate-like portion 33d is disposed on the outer circumferential side of the rotation tracks of the bush 3. The first extending portion 35 and the second extending portion 36 extend from the plate-like portion 33c formed on the inner circumferential side of the box-like portion 33. Owing to this construction, an increase in size on an outer circumferential side is suppressed. The first extending portion 35 and the second extending portion 36 are substantially in parallel with each other and have a space W1 therebetween. The first extending portion 35 has a projection 35f which protrudes toward the second extending portion 36. The second extending portion 36 has a projection 36f which protrudes toward the first extending portion 35. The projections 35f, 36f extend in moving directions of the bush 3. Owing to the projections 35f, 36f, the first extending portion 35 and the second extending portion 36 are suppressed from making contact with the sandwiched portion 49 of the child protecting member 4 by a larger area and makes line contact or close-to-line contact. Accordingly, even if a foreign substance such as mud enters between the first extending portion 35 and the sandwiched portion 49 or between the second extending portion 36 and the sandwiched portion 49, smooth mobility of the first extending portion 35 and the second extending portion 36 is secured, and accordingly, smooth mobility of the bush 3 is secured.

As shown in FIG. 11, the bush 3 has the push portion 3x formed integrally with the box-like portion 33 and protruding in a columnar shape. The push portion 3x has a function of being pushed by the inside lever 2 and a function of pushing the open lever 1.

As shown in FIG. 9, the child protecting member 4 has the sandwiched portion 49. The sandwiched portion 49 guides the first extending portion 35 and the second extending portion 36, while sandwiched by the first extending portion 35 and the second extending portion 36. The sandwiched portion 49 has a thickness t1 which is increased from a thickness t2 of the leg portion 47a, which is a neighboring portion of the sandwiched portion 49. Thus the sandwiched portion 49 is enforced in strength and rigidity. As a result, the first extending portion 35 and the second extending portion 36 can be restrained, and deformation by deflection of the guide portion 43 can be suppressed more effectively.

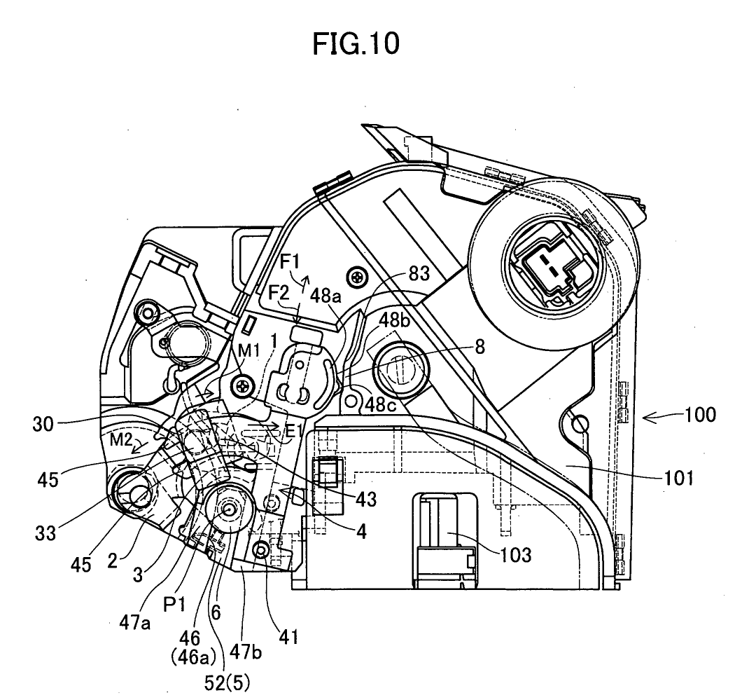

Moreover, as understood from FIG. 10, since the leg portions 47a, 47b of the child protecting member 4 are restrained both by the second engaging portion 52 of the base 5 and by the holder 6, the degree of restraint of the leg portions 47a, 47b is great. Regarding the child protecting member 4, the sandwiched portion 49 is provided near the leg portion 47a, which is placed under a high degree of restraint. Therefore, the sandwiched portion 49 is enforced in rigidity; and displacement of the first extending portion 35 and the second extending portion 36 of the bush 3 caused by deformation by deflection of the guide portion 43 is effectively suppressed. Consequently, displacement of the bush 3 and deformation by deflection of the guide portion 43 are further suppressed.

As shown in FIG. 9, when a notch groove 43r (a concave portion for elastically deforming the guide portion 43) is formed on a fore end of the guide portion 43 of the child protecting member 4, the guide portion 43 can be deformed by deflection in an inward direction of the notch groove 43r (the concave portion). Since the notch groove 43r (the concave portion) is formed, when the push 3 is attached on the snap portion 45 of the guide portion 43, the stopping pawl portions 45m, 45m of the guide portion 43 are deformed by deflection in the directions of the arrows C2 (shown in FIG. 9), and a distance between the stopping pawl portions 45m, 45m can be shortened. Consequently, an operation of attaching the bush 3 on the guide portion 43 can be carried out with ease.

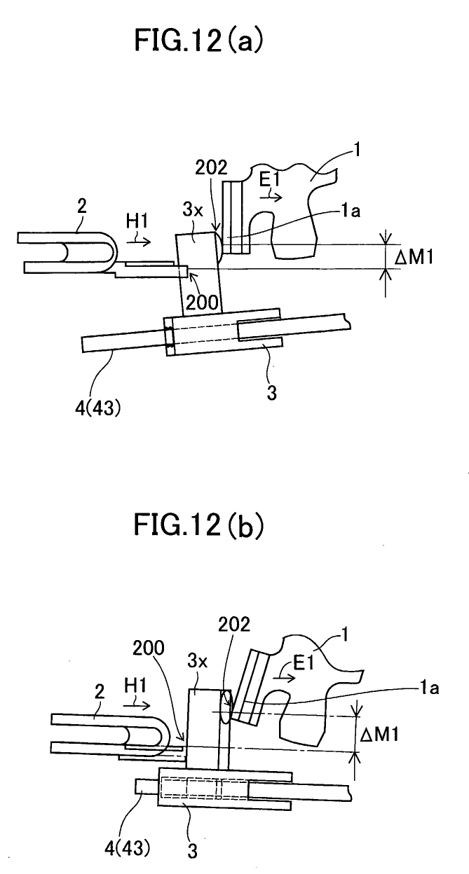

FIGS. 12(a) and 12(b) show that the inside lever 2 which is moved in the direction of the arrow H1 pushes the push portion 3x of the bush 3 and that the bush 3 pushes the open lever 1 in the direction of the arrow E1. In the first preferred embodiment, as shown in FIG. 12(a), there are a point 200 and a point 202. The point 200 is exerted by the inside lever 2 to push the push portion 3x of the bush 3 when the inside lever 2 is moved in the direction of releasing the door lock from the latched state (in the direction of the arrow Hi). The point 202 is exerted by the push portion 3x of the bush 3 to push the open lever 1. The points P1 and P2 are out of alignment with each other by a distance AM1. Due to an influence of this alignment, there arises a fear that the bush 3 might be inclined and consequently the guide portion 43 of the protecting member 43 might be deformed by deflection.

In this respect, according to this preferred embodiment, since the first extending portion 35 and the second extending portion 36 are provided on the bush 3 as a deformation suppressing portion for suppressing deformation by deflection of the guide portion 43 of the child protecting member 4, deformation by deflection of the guide portion 43 is suppressed. Therefore, as shown in FIG. 12(b), even when there is a misalignment by the distance ΔM1, displacement of the bush 3 and deformation by deflection of the guide portion 43 are suppressed. As a result, a loss is suppressed in transmitting application force and operational feelings of the inside handle are suppressed from being degraded.

According to this preferred embodiment, as shown in FIG. 9, the first extending portion 35 and the second extending portion 36 of the bush 3 are provided not in an outer circumferential side but in an inner circumferential side of rotation tracks of the bush 3. In this case, since the first extending portion 35 and the second extending portion 36 can be suppressed from protruding excessively on the outer circumferential side of these rotation tracks, this structure is advantageous in preventing an increase in size of the child protecting device.

As shown in FIG. 11, an inner wall surface 33i of the box-like portion 33 has a projection 33k for sliding. The projection 33k extends in the moving directions of the bush 3. When the guide portion 43 is fitted in the sliding recess 30 of the box-like portion 33, the projection 33k forms a gap for slide promotion between the inner wall surface 33i of the box-like portion 33 and an outer wall surface of the guide portion 43. Even if a foreign substance interposes between the inner wall surface 33i of the box-like portion 33 and the outer wall surface of the guide portion 43, this gap secures mobility of the bush 3.

According to this preferred embodiment, as shown in FIG. 9, the operating portion 41 to be operated by a user has a cylindrical shape standing in a perpendicular direction to the surface of the child protecting member 4 and provided by the leg portion 47b. As shown in FIG. 9, the temporary position holding portion 48 is provided on a fore portion of the child protecting member 4 and includes the concave portion 48a, the elastic arm portion 48b and the holding pawl portion 48c.

FIG. 10 illustrates a vehicular door lock device 100 on which the door-lock child protecting device according to this preferred embodiment is mounted. The door lock device 100 includes a housing 101 and a door latch 103 which can be engaged or disengaged with the door. As shown in FIG. 10, when a user moves the operating portion 41 in the direction of the arrow F2, the child protecting member 4 is moved rectilinearly in the same direction and disposed in the unset position S2 for not executing the child protecting function. When the child protecting member 4 is disposed in the unset position S2 and the door is closed, if the open lever 1 is moved in the direction of releasing the door lock from the latched state (in the direction of the arrow E1) due to an opening operation of the inside handle, the door latch 103 is moved in a direction of releasing the door lock from the latched state and the door is opened. On the other hand, when a user moves the operating portion 41 in the direction of the arrow F1, the child protecting member 4 is rectilinearly moved in the same direction and disposed in the set position S1 for executing the child protecting function. When the child protecting member 4 is disposed in the set position S1 and the door is closed, even if the inside handle is operated for opening the door, the open lever 1 is not moved in the direction of releasing the door lock from the latched state (in the direction of the arrow E1). Accordingly, the door latch 103 is not moved in the direction of releasing the door lock from the latched state, and the door is kept closed.

### Third Preferred Embodiment

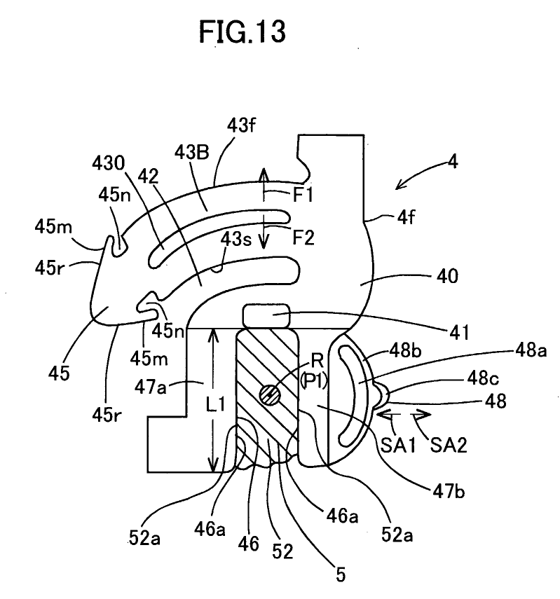

FIG. 13 illustrates a third preferred embodiment of the present invention. This preferred embodiment has basically the same construction, effects and advantages as those of the first preferred embodiment. Hereinafter, description will be made mainly on parts different from those of the first preferred embodiment. As shown in FIG. 13, a guide portion 43B of the child protecting member 4 has a reinforcing rib 430 formed in a longitudinal direction of the guide portion 43B. The reinforcing rib 430 serves as a deformation suppressing portion for suppressing deformation by deflection of the guide portion 43B of the child protecting member 4.

### Fourth Preferred Embodiment

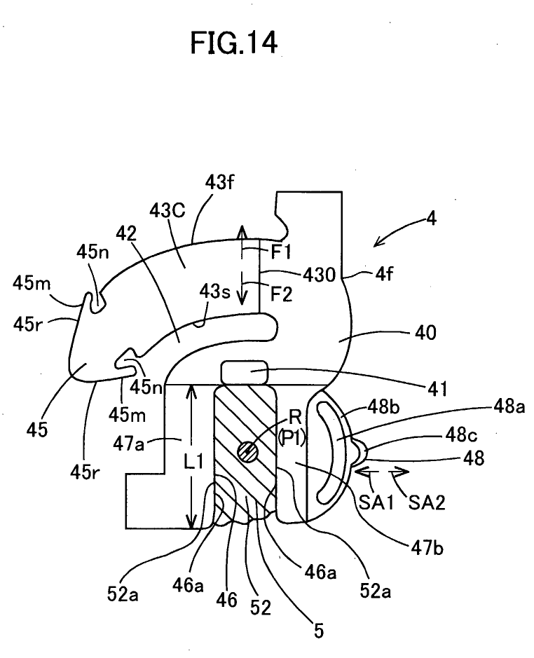

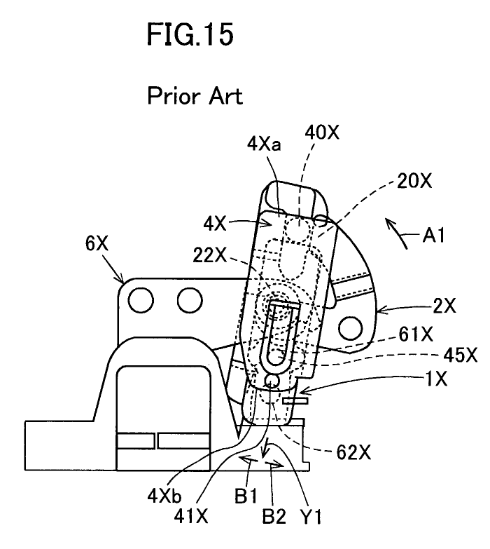

FIG. 14 illustrates a fourth preferred embodiment of the present invention. This preferred embodiment has basically the same construction, effects and advantages as those of the first preferred embodiment. Description will be made mainly on parts different from those of the first preferred embodiment. As shown in FIG. 14, a guide portion 43C is formed of a material which has a higher rigidity than that of the main body 40 of the child protecting member 4, such as high-alloy steel. An end surface 430 of the guide portion 43C is connected by welding to the main body 40. Accordingly, the guide portion. 43C is constructed to integrally have a deformation suppressing portion for suppressing deformation by deflection.

(Others)

According to the above preferred embodiments, the flange portion 61 of the holder 6 has a disk shape, but the shape is not limited to the disk shape and may be a rectangular plate shape. The shape of the bush is not limited to those described above, either. Besides, the present invention is not limited to the preferred embodiments described above and shown in the figures. Appropriate modification can be made to the working out of the present invention.

### INDUSTRIAL APPLICABILITY

The door-lock child protecting device is useful, for instance, as a child protecting device which is mounted inside a door panel of a vehicle and can select whether to execute the child protecting function of preventing a child in a passengers' room in a vehicle from opening a door or not.

1. A door-lock child protecting device, comprising:
an open member being movable in a direction of releasing a door lock from a latched state;
an inside lever for being actuated by an input from an inside handle;
a movable operating member for moving said open member in the direction of releasing the door lock from the latched state upon the actuation of said inside lever;
a child protecting member capable of being switched by an operation of an operating portion between a set position to execute child protection and an unset position not to execute child protection; and
a base having said open member, said inside lever, said movable operating member and said child protecting member thereon, and
said child protecting member has a plate shape and comprises a main body an operating portion formed on said main body so as to protrude in the thickness direction of said main body and having the shape of a projection to be moved by a user, and a guide projection which extends in an arm shape from said main body in a circular arc shape; and
said child protecting member which is arranged to be rectilinearly movable between the set position and the unset position, and which is inhibited from being rotated with respect to said base;
said movable operating member being able to make circular arc movements along said guide projection; and
when said child protecting member is disposed in the set position, said inside lever does not come in contact with said movable operating member; and
when said child protecting member is disposed in the unset position, the inside lever pushes said movable operating member and said movable operating member making the circular arc movement pushes said open member.

2. The door-lock child protecting device according to claim 1, wherein said child protecting member has a first engaging portion and said base has a second engaging portion engaged with said first engaging portion of said child protecting member,
one of said first engaging portion and said second engaging portion is a concave portion, and the other of said first engaging portion and said second engaging portion is a convex portion for being movably engaged with said concave portion, and
said child protecting member is arranged to be rectilinearly movable between the set position and the unset position and is inhibited from being rotated with respect to said base by said first engaging portion and said second engaging portion.

3. The door-lock child protecting device according to claim 1, wherein said child protecting member has a guide portion for guiding said movable operating member, and said movable operating member is moved with respect to said base along said guide portion of said child protecting member.

4. The door-lock child protecting device according to claim 3, wherein said guide portion of said child protecting member has a circular arc guide surface, and said movable operating member is rotated with respect to said base along said guide surface of said guide portion of said child protecting member and, in association with the rotation, said movable operating member moves said open member in the direction of releasing the door lock from the latched state.

5. The door-lock child protecting device according to claim 3, wherein said guide portion of said child protecting member has an engaging portion for suppressing removal of said movable operating member.

6. The door-lock child protecting device according to claim 3, wherein said guide portion of said child protecting member has a concave portion for deforming said guide portion elastically in attaching said movable operating member on said guide portion.

7. The door-lock child protecting device according to claim 2, wherein, when said child protecting member is disposed in the unset position, the amount of engagement between said first engaging portion of said child protecting member and said second engaging portion of said base is larger than when said child protecting member is disposed in the set position.

8. The door-lock child protecting device according to claim 1, wherein said movable operating member has a push portion for pushing said open member so as to move said open member in the direction of releasing the door lock from the latched state.

9. The door-lock child protecting device according to claim 1, wherein movement tracks of said movable operating member exist within said child protecting member.

10. The door-lock child protecting device according to claim 1, comprising a first holding element for holding said child protecting member in one of the set position and the unset position, and a second holding element for holding said child protecting member in the other of the set position and the unset position.

11. The door-lock child protecting device according to claim 4, wherein a deformation suppressing portion for suppressing deformation of said guide portion of said child protecting member is provided on at least one of said child protecting member, said movable operating member and said base.

12. The door-lock child protecting device according to claim 11, wherein said child protecting member has a sandwiched portion, and
said deformation suppressing portion has a first extending portion and a second extending portion both formed so as to extend from said movable operating member, and said first extending portion and said second extending portion are formed at such positions as to sandwich said sandwiched portion of said child protecting member in its thickness direction.

13. The door-lock child protecting device according to claim 11, wherein said deformation suppressing portion has a U-shape or a channel-shape in a cross section perpendicular to a moving direction of said movable operating member.

14. The door-lock child protecting device according to claim 12, wherein said movable operating member is rotated along said guide portion, and said first extending portion and said second extending portion of said movable operating member are provided on an inner circumferential side of rotation tracks of said moving operating member.

15. The door-lock child protecting device according to claim 12, wherein, in said child protecting member, said sandwiched portion sandwiched by said first extending portion and said second extending portion has a thickness increased from that of a neighboring portion of said sandwiched portion.

16. The door-lock child protecting device according to claims 11, wherein said deformation suppressing portion is a reinforcing rib formed on said guide portion of said child protecting member.
